(19) United States
(12) Patent Application Publication
(10) Pub. No.: US 2012/0039649 A1
(43) Pub. Date: Feb. 16, 2012

(54) FIXING APPARATUS, SYSTEMS, AND METHODS FOR PRINTING

(75) Inventors: Grace T. BREWINGTON, Fairport, NY (US); Anthony S. Condello, Webster, NY (US); Barry P. Mandel, Fairport, NY (US); Dale R. Mashtare, Bloomfield, NY (US); Jeffrey W. Drawe, Bloomfield, NY (US)

(73) Assignee: XEROX CORPORATION, Norwalk, CT (US)

(21) Appl. No.: 13/112,604

(22) Filed: May 20, 2011

Related U.S. Application Data
(63) Continuation-in-part of application No. 12/855,011, filed on Aug. 12, 2010.

(51) Int. Cl. G03G 15/20

(52) U.S. Cl. 399/333

(57) ABSTRACT

Fixing systems apply at a fixing nip low or ambient temperatures and moderate pressures or relatively high pressures to a substrate on which marking material is deposited. Fixing systems are integrated with a base print engine of a printing system, or added inline as a module to a printing system. Fixing systems and printing systems containing fixing devices and systems, including multi-stage fixing systems accommodate a broad range of substrates.

### RELATED APPLICATIONS

This application is a continuation-in-part of U.S. patent application Ser. No. 12/855,011, entitled MULTI-STAGE FIXING SYSTEMS, PRINTING APPARATUSES AND METHODS OF FIXING MARKING MATERIAL TO SUBSTRATES, the entire disclosure of which is incorporated herein by reference in its entirety. This application is related to the applications entitled “FIXING DEVICES FOR FIXING MARKING MATERIAL TO A WEB WITH CONTACT PRE-HEATING OF WEB AND MARKING MATERIAL AND METHODS OF FIXING MARKING MATERIAL TO A WEB” (Attorney Docket No. 056-0238); “FIXING DEVICES INCLUDING LOW-VISCOSITY RELEASE AGENT APPLICATOR SYSTEM AND METHODS OF FIXING MARKING MATERIAL TO SUBSTRATES” (Attorney Docket No. 056-0242); “FIXING DEVICES INCLUDING CONTACT PRE-HEATER AND METHODS OF FIXING MARKING MATERIAL TO SUBSTRATES” (Attorney Docket No. 056-0252); “FIXING SYSTEMS INCLUDING IMAGE CONDITIONER AND IMAGE PRE-HEATER AND METHODS OF FIXING MARKING MATERIAL TO SUBSTRATES” (Attorney Docket No. 056-0255); “FIXING DEVICES INCLUDING EXTENDED-LIFE COMPONENTS, PRINTING APPARATUSES AND METHODS OF FIXING MARKING MATERIAL TO SUBSTRATES” (Attorney Docket No. 056-0271); and “LOW ADHESION COATINGS FOR IMAGE FIXING” (Attorney Docket No. 0010.0219); and METHODS, APPARATUS, AND SYSTEMS FOR CONTROLLING GLOSS OF AN IMAGE FIXED BY WARM-PRESSURE FIXING (Attorney Docket No. 056-0270), the entire disclosures of which are incorporated herein by reference in their entirety.

### FIELD OF DISCLOSURE

Apparatus, systems, and methods of embodiments relate to fixing marking material to a substrate. Specifically, methods, apparatus, and systems of embodiments relate to printing systems that incorporate contact fixing.

### BACKGROUND

In related art printing systems, marking material such as toner is applied to a substrate to form an image. The marking material that forms the image may be fixed or fused to the substrate by thermal fusing. Thermal fusers such as those used in electrophotographic printing typically operate at high temperatures, e.g., about 150° C. to about 210° C. The energy is used to promote cohesion of toner particles, and promote adhesion of the particles to the substrate. The high temperatures required for thermal fusing limit substrate options, and limit efficiency by requiring expensive and time-consuming make-ready and specific parameters per, e.g., substrate, and requiring short-run times. Further, the high temperatures typically used for thermal fusing may require cumbersome and expensive post-fusing cooling equipment to minimize image degradation.

For example, thermal fusers may super-heat a substrate with a layer of partially molten marking material such as toner, thereby increasing the potential for image artifacts. A molten toner layer may be vulnerable to offsetting to an adjacent surface, e.g., a transport belt, baffle, sheet of paper or other media substrate, etc. The cooling marking material and/or substrate may take on the surface texture of another surface that the substrate comes into contact with. Further, the substrate may cool differentially by way of contact, thereby making it difficult to store (e.g., by stacking or winding) after fusing, often requiring expensive cooling equipment for post-fusing processing prior to storage. Marking materials such as ultra-low melting toners tend to increase the potential for image artifacts.

### SUMMARY

Related art thermal fusers are typically designed to satisfy space, speed, cost, and quality requirements for a particular market segment. For some purposes, it is neither practical nor desirable to supply a highest quality, highest cost output capability to all customers. Some customers are willing, however, to pay for increased quality or enhanced control over print output.

Related art printing systems are restricted to a limited range of substrate variability and may require expensive pre and post-processing procedures and mechanisms. There is a need for printing systems and components that, e.g., accommodate a range of substrate variability and efficient volume printing. For example, related art label printing is predominantly accomplished by way of flexography and offset lithography. These technologies are not suitable for short run times because they require expensive plates/cylinders and time consuming press preparation.

Fixing systems for warm-pressure fixing marking material to a substrate, printing apparatus and systems including the same, and methods of fixing marking material to a substrate in printing are disclosed. In an exemplary embodiment, a fixing system may be a multi-stage fixing system. The multi-stage fixing system may have a softening device for softening toner applied to a substrate by a marking device; and a fixing device for fixing the softened toner to the substrate. In alternative embodiments, the fixing system may operate without a softening device or other components of a multi-stage fixing system, and may be a single-stage fixing system.

In an embodiment, the fixing device may include a first fixing member having a first surface and a second fixing member having a second surface, the first surface and the second surface defining a fixing nip at which warm-pressure fixing conditions are applied. Specifically, a heat source heats at least one of the first surface and the second surface for applying heat at the fixing nip. For example, the nip may be heated to a temperature in a range of about 50° C. to about 120° C. At least one of the first fixing member and the second fixing member are operable to apply pressure to the substrate and toner received at the fixing nip to fix the toner to the substrate. Exemplary pressures to apply at the fixing nip for fixing toner are in a range of about 300 psi to about 1500 psi. For example, a pressure in a range of about 400 psi to 1000 psi, and preferably about 500 psi, may be applied at the nip. Ranges may vary according to a type of marking material used.

In another embodiment, an electrophotographic printing system that prints toner on a substrate includes a warm-pressure fixing module. The fixing module may be incorporated inline into a printing system. The fixing module may include a first fixing member and a second fixing member, the first fixing member and the second fixing member defining a nip. At the nip, at least one of the first fixing member and the second fixing member apply a pressure of about 300 psi to about 1500 psi to marking material such as toner on a substrate that passes through the nip. For example, a preferred pressure of about 500 psi may be applied.

In an embodiment, an electrophotographic printing system may include a base print engine that deposits marking material on a substrate. The base print engine may include a four-color marking station system. The printing system may include a fixing system having a first fixing member and a second fixing member. In another embodiment, the base print engine may include a supplemental marking station that includes additional color marking material such as white, or overcoat material. The fixing system may be positioned inline after the base print engine. In an alternative embodiment, the fixing system may be a fixing module that is added to the printing system to enhance inline fixing. The fixing system may be incorporated inline in the printing system, after the base print engine. The base print engine may incorporate direct image transfer or intermediate image transfer.

In an embodiment, the printing system may include a supplemental marking station located at least one of before and after the base print engine. The supplemental marking station itself may include a warm-pressure fixing system. The fixing system of the supplemental marking station may be separate from a fixing system configured to fix marking material deposited by the base print engine. In yet another embodiment, a supplemental marking station may be an inkjet marking station, and may be associated with a UV curing system. The one or more fixing systems of the printing system may include a first fixing member and a second fixing member that define a fixing nip at which the fixing system applies a pressure of about 300 psi to about 1500 psi, e.g., about 500 psi to the marking material deposited on the substrate as the substrate passes through the fixing nip.

An exemplary embodiment in accordance with methods includes a method of electrophotographic printing using a printing system having a base print engine and a fixing system, the fixing system having a first fixing member and a second fixing member, the first and second fixing members defining a fixing nip. At least one of the first fixing member and the second fixing member may be heated; and at least one of the first fixing member and the second fixing member may be a pressure member. For example, the method may include transferring an image to a substrate; and warm-pressure processing the image on the substrate at the fixing nip. Methods and systems include storing the warm-pressure fixed substrates by, e.g., stacking or rewinding a continuous web using a web transport system. Warm-pressure fixing may obviate the need to use expensive post-fixing cooling equipment to minimize deleterious side effects of thermal fusing such as offsetting, etc.

In another embodiment, methods and systems may include applying marking material using a photoreceptor member. The photoreceptor member carries a marking material image deposited thereon by a base marking material print engine. The marking material image may be directly transferred to, e.g., a paper substrate. In alternative embodiments, methods may include using an intermediate image transfer member, e.g., a belt for carrying and transferring a marking material image to a substrate. An image transfer nip member that defines an image transfer nip may be electrically biased to enhance image transfer of the marking material image to a substrate.

Following transfer, the marking material image may be warm-pressure fixed to the substrate at a fixing nip defined by a first fixing member and a second fixing member, which may be a heated roll or belt and/or a pressure roll or member. The nip may be heated to a temperature in a range of about 50° C. to about 120° C. A pressure may be applied at the nip, the pressure being in a range of about 300 psi to about 1500 psi, and preferably 500 psi.

Exemplary embodiments are described herein. It is envisioned, however, that any system that incorporates features of methods, apparatus, and systems described herein are encompassed by the scope and spirit of the exemplary embodiments.

### DRAWINGS

FIG. 1 shows a printing apparatus having fixing system in accordance with an exemplary embodiment;

FIG. 2 shows a fixing system in accordance with an exemplary embodiment;

FIG. 3 shows a tandem engine printing system with an intermediate belt for electrophotographic image transfer and a fixing system in accordance with an exemplary embodiment;

FIG. 4 shows a diagrammatical side view of an intermediate belt configuration printing system having a four color base print engine, and a fixing system in accordance with an exemplary embodiment;

FIG. 5 shows a diagrammatical side view of an intermediate belt configuration printing system having a four color base print engine, and clear marking material station, and a fixing system in accordance with an exemplary embodiment;

FIG. 6 shows a diagrammatical side view of an intermediate belt configuration printing system having a tandem four color base print engine, a white marking material station, a fifth color marking station, and a fixing system in accordance with an exemplary embodiment;

FIG. 7 shows a diagrammatical side view of an intermediate belt configuration printing system in accordance with an embodiment having a four color base print engine, a white marking material engine positioned before the base print engine, and a fixing system positioned after the base print engine;

FIG. 8 shows a diagrammatical side view of an intermediate belt configuration printing system in accordance with an embodiment having a four color base print engine, an inkjet engine and UV curing system positioned before the base print engine, and a fixing system positioned after the base print engine;

FIG. 9 shows a diagrammatical side view of an intermediate belt configuration printing system in accordance with an embodiment having a four color base print engine, a white color marking material engine positioned before the base print engine, and a gamut expansion engine supplementing the base print engine, and a fixing system in accordance with an exemplary embodiment;

FIG. 10 shows a printing system having a photoreceptor image transfer member and a fixing system in accordance with an exemplary embodiment;

FIG. 11 shows a plot of fixing pressure versus fixing temperature to achieve a selected image fix level of a toner to uncoated paper with fixing devices that utilize high pressure and low temperature, low temperature and moderate pressure, and high temperature and low pressure.

### DETAILED DESCRIPTION

Printing apparatus and systems rely on a variety of techniques to fix marking material to a substrate. Marking material may comprise, for example, dry toner, and may be deposited on a substrate to form an image, which is then fixed to the substrate using non-contact methods and systems or contact methods and systems.

In non-contact methods and systems, marking material may be fixed to a substrate by heating the marking material using a radiant energy source. This process requires little or no pressure, and relies upon radiant energy absorption by the marking material and viscoelastic flow. Using radiant energy methods alone to fix marking material to substrates has been found to limit image quality, limit substrate compatibility, and increase material costs due to additional property demands placed on the marking material.

In contact methods and systems, a substrate having marking material deposited thereon may be fed to a fixing nip defined by two opposing fixing members. The opposing fixing members may comprise a fixing roll or fixing belt. One of the fixing roll or fixing belt may be heated by a heat element, and one of the fixing members may be a pressure roll. Adequate thermal energy and pressure may be applied at the nip to fix the marking material to the substrate.

Related art contact fixing systems typically apply relatively low fixing pressures, e.g., about 60 psi to about 100 psi, and high fixing temperatures at a fixing nip to fix, e.g., dry toner onto a substrate at the fixing nip in milliseconds of dwell time. For example, in related art systems, a surface of the fixing members may be heated to a temperature in a range of about 150° C. to about 210° C. Such high-temperature conditions necessitate that the fixing members be composed of durable materials, e.g., high-temperature compatible elastomeric materials. Such high fixing temperatures also cause related art fixing systems to have limited substrate compatibility, require costly components, and low image quality, due to, e.g., problems that arise during post-fixing processing.

Embodiments of apparatus, systems, and methods include a fixing system that applies warm-pressure fixing conditions. In a preferred embodiment, the fixing system may be a multi-stage fixing system. In an alternative embodiment, the fixing system may include a single-stage fixing system for fixing marking material, e.g., toner to a substrate. Printing systems in accordance with embodiments may include one or more fixing systems or devices. The one or more fixing systems may be used to fix marking material to substrate and/or enhance fixing of marking material previously fixed by other means, e.g., non-contact fixing etc.

In an exemplary embodiment, a fixing system may have a fixing device including a first fixing member and a second fixing member. The fixing members may be a roll structure, or other suitable structure such as a belt. The fixing members define a nip at which a substrate may be processed to fix marking material thereon by applying warm-pressure fixing conditions, i.e., relatively lower fixing temperatures than those used in the related art, and moderate pressures.

Specifically, at least one of the first fixing member and the second fixing member may be heated by a heating element during fixing. One or more of the fixing members are configured to apply a pressure at the nip during fixing. The fixing system may apply a temperature in a range of about 50° C. to about 120° C., and a pressure in a range of about 300 psi to about 1500 psi. For example, the fixing device of the fixing system may apply a pressure in a range of 400 psi to 1000 psi. In a preferred embodiment, the fixing system may apply a pressure of about 500 psi. Such conditions relax demands on marking material, provide high image quality, a high level of printed permanence, and reduce overall printing costs.

Multi-stage fixing systems in accordance with embodiments may include a softening device for softening toner applied to a substrate by a marking device. The substrate and softened toner may be fed to a nip of a fixing device. Specifically, the fixing device may include a first fixing member having a first surface. A second fixing member having a second surface may define a fixing nip with the first surface, at which the substrate with softened toner is received. The first fixing member and the second fixing member are operable to apply pressure to the substrate and softened toner received at the fixing nip to fix the toner to the substrate. Heat may also be applied at the fixing nip to fix the softened toner to the substrate. Multi-stage fixing systems may further reduce demands on fixing device components and accommodate broader substrate variability by enabling lower temperatures to be effectively used at the fixing nip.

For example, in an embodiment of multi-stage fixing systems, a softening device having a first thermal energy source may pre-heat toner applied to a substrate by a marking device to a first temperature of about 50° C. to about 110° C. to soften the toner. The multi-stage fixing system may include a fixing device, positioned downstream from the softening device, with respect to a process direction. The fixing device may be constructed and configured to fix the softened toner to the substrate under warm-pressure fixing conditions. For example, the fixing device may apply a pressure in a range of about 300 psi to about 1500 psi, e.g., a pressure in a range of about 400 psi to about 700 psi, and preferably about 500 psi to fix toner to substrate. The fixing device may heat the fixing nip and/or one or more fixing members that define the nip to a temperature in a range of about 50° C. to about 120° C. In multi-stage fixing systems, a lower temperature may be used where the toner is softened by the softening device prior to the toner and substrate arriving at the fixing nip.

Printing systems may include one or more fixing systems and/or devices for fixing or supplementing fixing of marking material to a substrate, including multi-stage fixing systems. For example, an embodiment of a fixing system may be a module having a fixing device that may be used to enhance other fixing methods. The module may be added to an existing printing system. Alternatively, a fixing system may be incorporated in-line in a printing system. A printing system may include more than one fixing device and/or system. For example, a printing system may include a supplemental marking engine having an associated fixing system, and a base print engine having another associated fixing system. The above-discussed exemplary temperatures and pressures generally relate to toner, and may be adjusted for different marking materials as appropriate.

Methods of fixing material to a substrate in accordance with embodiments may include applying marking material such as toner to a substrate with a marking device. Methods may include feeding the substrate to a fixing nip of a fixing system, the fixing system comprising a first fixing member including a first surface and a second fixing member including a second surface, the fixing nip being formed or defined by the first surface and the second surface. The fixing members may be rotatable rolls, belts or other suitable structures. Methods may include heating at least one of the first surface of the first roll and the second surface of the second roll with a thermal energy source(s); and applying heat and pressure to the substrate and marking material at the nip to fix the marking material to the substrate under warm-pressure fixing conditions.

In another embodiment, methods of fixing marking material to a substrate in printing may include applying, e.g., toner to a substrate with a marking device; and pre-heating the toner applied to the substrate with a first thermal energy source of a softening device of a multi-stage fixing system, the toner being pre-heated to a temperature in a range of about 50° C. to about 110° C. to soften the toner. The substrate may be fed to a fixing nip of a fixing device of the multi-stage fixing system. The fixing device may include a first fixing member having a first surface and a second fixing member having a second surface, the fixing nip being formed by the first surface and the second surface.

Warm-pressure fixing conditions may be applied at the nip to the substrate having softened marking material. Specifically, a temperature in a range of about 50° C. to about 120° C. may be applied at the nip. A pressure in a range of about 300 psi to about 1500 psi, e.g., a pressure in a range of about 400 psi to about 700 psi, and preferably about 500 psi to fix toner to substrate. The step of softening the toner can enable lower temperatures to be applied at the fixing nip, thus expanding substrate options and improving print efficiency and performance.

Reference is made to the drawings to accommodate understanding of apparatus, systems, and methods for fixing marking material to a substrate. In the drawings, like reference numerals are used throughout to designate similar or identical elements. The drawings depict various embodiments and illustrative apparatus, systems, and methods for fixing marking material to a substrate.

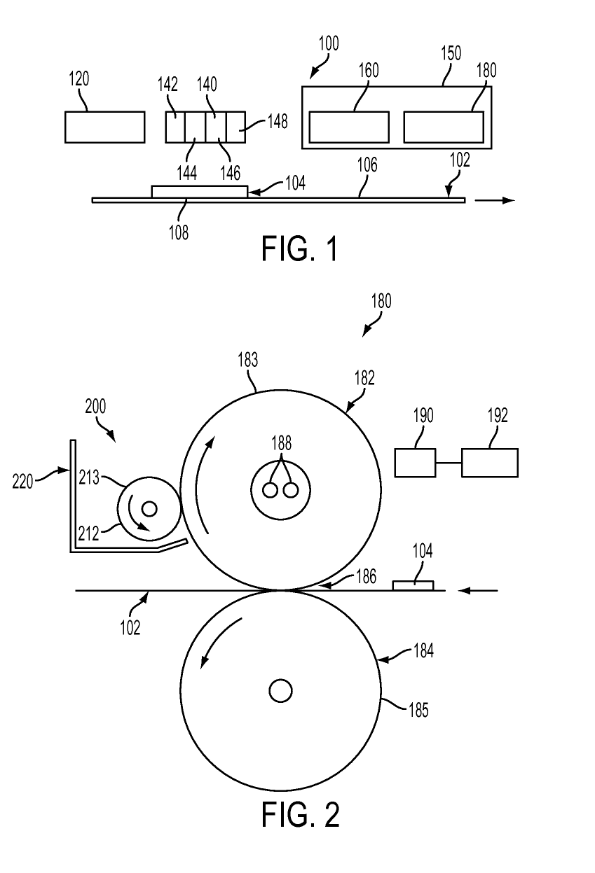

FIG. 1 depicts an exemplary embodiment of a printing apparatus 100 that forms images on a substrate 102. The substrate 102 is a sheet. In alternative embodiments, the printing apparatus 100 may be configured to print to a continuous web. The substrate 102 may comprise paper, which can be coated or uncoated. The substrate 102 may comprise packaging material.

The printing apparatus 100 includes a substrate feeding device 120, a marking device 140 and a multi-stage fixing system 150 including a softening device 160 and a fixing device 180 located downstream from the softening device 160. The substrate 102 may be fed by the substrate feeding device 120 to the marking device 140 to apply marking material 104 to a front surface 106 of the substrate 102. The marking material 104 comprises toner. The substrate 102 may then be fed to the multi-stage fixing system 150. The applied toner may be softened by the softening device 160. Then, the substrate 102 may be advanced to the fixing device 180 where heat and pressure are applied to adequately fix the softened toner to the front surface 106.

Embodiments of the marking device 140 can have any suitable configuration for applying marking material comprising toner to the substrate 102. In embodiments, the toner material may comprise dry toner particles. The toner material may be a conventional toner or chemical toner. The toner may contain one or more additives. In the marking device 120, carrier particles may be used to assist in delivery of the toner material. The marking device 140 may be constructed to apply marking material directly to the substrate 102 to form toner images. In other embodiments, the marking device 140 may be constructed to apply marking material first to an intermediate image transfer member, such as a roll or belt, and then to transfer the marking material from the intermediate member to the substrate 102.

The marking device 140 shown in FIG. 1 includes four marking stations 142, 144, 146 and 148 arranged in series along the process direction of the printing apparatus 100. The marking stations 142, 144, 146 and 148 can each apply a marking material comprising a different color of toner material, such as black, cyan, magenta and yellow toner, respectively, to the front surface 106 of the substrate 102 to form a color image. The marking device 140 can also be used to produce monochromatic images. While the marking device 140 is shown as applying marking material 104 only to the front surface 106 of the substrate 102, alternative embodiments of the printing apparatus 100 can be configured to produce duplex prints.

In embodiments of the printing apparatus, the substrate 102 and marking material 104 may or may not be actively heated before the substrate 102 arrives at the softening device 160 of the multi-stage fixing system 150. When the substrate 102 and marking material 104 are not actively heated with a heating device to increase their temperature before the substrate 102 arrives at the softening device 160, the substrate 102 and marking material 104 are typically at about the ambient temperature of the cavity of the printing apparatus 100 when the substrate 102 arrives at the softening device 160.

The softening device 160 may be provided in the multi-stage fixing system 150 to soften the toner on the substrate 102 before entering the fixing device 180. As used herein, the term “soften” means to reduce the elastic modulus of the toner. Some adhesion of the toner to the substrate and some coalescence of the toner particles may occur as a result of the softening with the softening device 160. The softened toner may be in a condition between being completely unfused and being completely fused (fully fused) to the substrate. The amount of fixing or fusing resulting from this first softening step is considered to be insufficient for the prints to be suitable for nominal applications. Additional fixing or fusing of the toner is achieved by the fixing device 180.

The softening device 160 may include at least one thermal energy source operable to pre-heat the substrate 102 and marking material 104 on the front surface 106 to achieve a sufficiently-high temperature at the interface 108 between the substrate 102 and marking material 104 to soften the toner. The softening device 160 may heat the substrate 102 and toner to achieve a temperature at the interface 108 of at least about 50° C., such as about 50° C. to about 110° C., about 50° C. to about 100° C., or about 60° C. to about 90° C. At the softening device 160, the toner may be subjected to a mechanical pressure of, e.g., about 300 psi to about 1000 psi to produce mechanical leveling or spreading of the toner on the substrate 102.

In embodiments, the temperature at the interface 108 between the substrate 102 and marking material 104 can be raised to above the glass transition temperature and/or above the melting temperature of the overall toner to soften the toner material. For some formulations of the toner, at the interface 108, the toner may become a mixed phase resulting from plasticization of the toner. By pre-heating the substrate 102 and marking material 104 to temperatures of less than 100° C., for example, problems caused by the vaporization of water contained in print media, which include damage to the media (blistering) and/or damage to the images, can be avoided in the printing apparatus 100.

The softening device 160 may include any suitable thermal energy source that can pre-heat the substrate 102 and toner to the desired temperature to soften the toner. For example, the softening device 160 may include one or more non-contact heating devices, such as one or more radiant heating devices that emit radiant energy onto the substrate 102 and toner. The radiant heating devices may comprise flash lamps, or the like, which emit short-duration, high-intensity radiant energy; or lamps, light emitting diodes, or the like, which can emit radiant energy continuously; or convective heating devices, such as forced hot air or steam emitting devices, that apply a heated gas or vapor to the substrate 102 and marking material 104.

Pre-heating the substrate 102 and toner using the softening device 160 supplies energy to the substrate 102 and toner, which allows the fixing device 180 to be operated at lower fixing temperatures than fixing devices that, for example, do not use pre-heating and must heat toner from ambient temperature to the fixing temperature at the fixing nip within a short dwell time. In the printing apparatus 100, a lower fixing temperature can be used in the fixing device 180 for the same process speed, as compared to that which would have been applied in conventional fusing processes. This temperature of the fixing device 180 may be increased, as needed, to achieve toner fixing at higher process speeds.

In alternative embodiments, the softening device 160 may use chemical softening of the toner on the substrate 102, which comprises exposing the toner to a chemical effective to soften the toner. These softening techniques can be used alone, or in combination with heating of the toner.

The fixing device 180 is constructed to heat the softened toner to a sufficiently-high temperature with applied pressure to cause the softened toner to coalesce and provide adequate adhesion of the image to the substrate 102. When the softening device 160 pre-heats the toner, it may be desirable to minimize the distance along the process direction between the outlet end of the softening device 160 and a fixing nip 186 of the fixing device 180 in order to minimize cooling of the pre-heated toner prior to reaching the fixing nip 186. For example, the pre-heated substrate 102 can typically be advanced from the outlet of the softening device 160 to the fixing nip 186 within about 50 ms to about 1000 ms.

A fixing device is shown in FIG. 2. Specifically, a fixing device 180 may include a fixing roll 182 and a pressure roll 184, which together form the fixing nip 186. The substrate 102 is fed to the fixing nip 186 at which the substrate 102 and marking material 104 may be subjected to heating and applied pressure by the fixing roll 182 and pressure roll 184. In other embodiments, the fixing device may have a construction including a belt configuration for one or more of the fixing members, such as a fixing belt that is entrained on one or more rolls and arranged in combination with the pressure roll 184 to form a fixing nip at which thermal energy and pressure may be applied to a substrate and toner.

The fixing roll 182 may be internally and/or externally heated by a thermal energy source to a desired temperature. As shown, the thermal energy source may include internal heating elements 188, such as axially-extending lamps, located inside of the fixing roll 182 and powered to heat the outer surface 183 to the fixing temperature. A power supply 190 may be connected to the heating elements 188. The power supply 190 may be connected to a controller 192, which may be configured to control the supply of power to the heating elements 188. In other embodiments, the outer surface 183 may be externally heated by a thermal energy source by conduction, convection and/or radiation. For example, at least one external heating roll may be provided in contact with the outer surface 183.

In embodiments, the outer surface 183 of the fixing roll 182 may comprise a metallic material, a ceramic material, or a composite material. For example, the fixing roll 182 may comprise an aluminum substrate that has been subjected to an anodizing process to convert the surface region of the substrate, including the outer surface 183, to porous anodized aluminum (aluminum oxide, Al₂O₃). The open pores of the anodized surface region can be impregnated with a suitable material to seal the open pores. For example, the open pores may be impregnated with a substance having lubricating properties, such as polytetrafluoroethylene (Teflon®), or the like, to seal the pores. The resulting outer surface 183 provides a desirable hardness and release properties.

Following the sealing process, the outer surface 183 may be polished to a smooth finish. To achieve uniform pressures at the fixing nip 186 along the axial length of the fixing roll 182 over the entire applied pressure range, the fixing roll 182 or the pressure roll 184 may be crowned.

In other embodiments, the fixing roll 182 may include one or more outer layers, each comprising a polymer or a polymer composite material. The outermost outer layer includes the outer surface 183. For example, the polymer can be polyurethane, nitrile butadiene rubber, or the like. Each outer layer may have a thickness of, e.g., about 1 mm to about 15 mm. It is desirable to minimize the thickness of the outer layer(s) to improve thermal conductivity and allow desirable fixing performance in the temperature range of about 50° C. to about 120° C. The outer layer(s) may contain one or more filler materials to increase thermal conductivity, improve durability and/or improve static charge buildup. The outer layer(s) may provide improved spreading of toner during the fixing process, and improved release performance by the fixing roll 182.

In the low-temperature, moderate-pressure regime in which the warm-pressure fixing device 180 can be operated, embodiments of the fixing roll 182 that include an outer surface 183 comprised of anodized aluminum, and embodiments that include one or more polymeric outer layers, provide resistance to the complex mechanical and chemical interactions that occur at the fixing nip 186 during fixing of toner to substrates.

In embodiments, the pressure roll 184 may comprise a core and a polymeric material overlying the core and forming the outer surface 185. For example, the polymeric material may be polyurethane, nitrile butadiene rubber, or the like. The polymeric material can be applied as a single layer, or as two or more layers. Different layers of the multi-layer constructions may have a different composition and properties from each other, e.g., a different elastic modulus. The pressure roll 184 may be heated.

In the warm-pressure fixing device 180, the outer surface 183 of the fixing roll 182 may be heated to a temperature that is suitable for warm-pressure fixing the toner formulation to the substrate 102. In embodiments, the temperature of the outer surface 183 (i.e., the fixing temperature) may be set to at least about 50° C., such as about 50° C. to about 120° C., about 70° C. to about 110° C., about 80° C. to about 110° C., or about 80° C. to about 100° C., for fixing the softened toner on the substrate 102. When the toner is softened by pre-heating, a relatively lower fixing temperature may be used in the fixing device 180 as compared to embodiments in which the toner is softened without pre-heating at the softening device 160. The outer surface 183 may be operated at a fixing temperature that is close to the pre-heated temperature of the toner, e.g., less than about 10° C. higher, or less than about 5° C. higher, than the pre-heated temperature. In alternative embodiments, the fixing device 180 may be configured to fix marking material that is not preheated, and may be included in systems without a softening device.

During fixing, the toner image may be highly viscous. Moderate pressure is applied at the fixing nip 186 to ensure adequate adhesion to the substrate and good coalescence for permanence and high image quality. In embodiments, the amount of pressure applied to the substrate 102 at the fixing nip 186 may range from about 300 psi to about 3000 psi, such as about 300 psi to about 1500 psi, or about 400 psi to about 1000 psi. For example, a preferred pressure of about 500 psi may be used.

In the printing apparatus 100, the pre-heating temperature achieved by the softening device 160 and the fixing temperature achieved by the fixing device 180 can be adjusted for different substrate materials and types. For a heavy-weight paper substrate 102 (coated or uncoated), the pre-heating temperature and/or the fixing temperature can be increased at a given dwell time, as compared to the pre-heating and fixing temperatures used for a light-weight paper substrate 102.

The temperature and pressure conditions used at the softening device 160 and the fixing device 180 may be selected based on the melting temperature of the toner material used to form prints. For example, in an embodiment, the softening device 160 may be operated at a pre-heating temperature of about 80° C. to about 90° C., and the fixing device 180 can be operated at a fixing temperature of about 80° C. to about 100° C. and a nip pressure of about 400 psi to about 700 psi to fix a first toner material to substrates. For a second toner material having a higher melting temperature than the first toner material, the softening device 160 can be operated at a pre-heating temperature of about 90° C. to about 110° C., and the fixing device 180 can be operated at a fixing temperature of about 100° C. to about 110° C. and a nip pressure of about 400 psi to about 700 psi to fix the second toner material to substrates. In embodiments, the pre-heating temperature and the fixing temperature can be configured to melt the toner material at the fixing nip. In preferred embodiments, the nip pressure may be about 500 psi.

As shown in FIG. 2, the fixing device 180 may include a release agent applicator system 200 for applying a release agent to the outer surface 183 of the fixing roll 182. The release agent is formulated to prevent adherence of toner to the fixing roll and to assist in stripping of the substrate from the fixing roll following fixing. The illustrated release agent applicator system 200 includes a release agent applicator roll 212 having an outer surface 213. The applicator roll 212 is rotatable to apply release agent to the outer surface 183. A tray 220 is positioned to collect residual release agent.

Softening of toner combined with use of a relatively lower temperature at the fixing nip 186 may be further enabled through the use of low-melting and ultra-low-melting toner materials characterized as having a melting temperature that is altered (lowered) by heating the toner to a temperature above a threshold temperature and then re-heating the toner having the lowered melting temperature. Exemplary ultra-low-melting toners having these characteristics comprise a crystalline polymer material, such as crystalline polyester material, and an amorphous polymer material, such as amorphous polyester material, with the amorphous material having a glass transition temperature (T_{g}) separate from the melting temperature (Tₘ) of the crystalline material. In these toners, the crystalline polymer material imparts a low melting temperature to the toner. Exemplary toners having alterable melting temperature characteristics that may be used in the fixing device are disclosed in U.S. Pat. Nos. 7,402,371; 7,494,757 and 7,547,499, each of which is incorporated herein by reference in its entirety.

Toners having such temperature-alterable melting characteristics can be used in the fixing device 180 to further enhance the effectiveness of the pre-heating of the substrate 102 and toner in the fixing process. These toners can undergo a reduction in their melting temperature prior being fixed to the substrate 102 at the fixing nip 186 by being pre-heated using the softening device 160. As the substrate 102 is advanced to the fixing nip 186, additional thermal energy is applied to the substrate 102 and toner with the heated fixing roll 182.

Using a toner material having a low melting temperature, allows the process conditions of temperature (thermal energy input), pressure and/or dwell (print speed) to be lowered in the fixing nip 186 of the fixing device 182. Suitable toner materials may be expanded over other fusing approaches to provide optimal image quality, and low materials cost is enabled.

By operating at reduced toner temperatures in embodiments of the warm-pressure fixing systems, printing apparatus, and methods, improved system/substrate path robustness without toner blocking problems in output stacks can be achieved.

The operating set-points used in embodiments of the fixing systems and printing apparatus accommodate low substrate temperatures. Therefore, substrate distortion issues that can occur at elevated process temperatures may be avoided, thereby extend the substrate application space available for printing systems. For example, polymeric film materials used in packaging may be used as the substrate in fixing systems and printing apparatus. The use of low operating temperatures also reduces or avoids water evaporation and reabsorption by paper and, consequently, can minimize or eliminate this potential source for paper distortion.

### Examples

A fixing system including a softening device having a radiant heater for pre-heating, and a fixing device including a fixing roll and pressure roll are used. The fixing roll is an aluminum roll with a polished, anodized aluminum surface. A light coating (˜1 mg/sheet) of release agent (Copy Aid 270 silicone fluid manufactured by Wacker Chemical Corporation of Adrian Mich.) is applied to the anodized aluminum surface. Uncoated and coated paper substrates are used. The toner applied to the substrate has a low melting point. The toner contains a crystalline polyester resin, an amorphous polyester resin and a wax, and is cyan colored. The amorphous base resin has a glass transition onset temperature, T_{g}, of 47° C., the crystalline polyester resin has a melting temperature, CPE Tₘ, of 66° C., and the wax has a melting temperature, Wax Tₘ, of 88° C. The substrate with applied toner is passed beneath the radiant heater element to elevate the temperature of the toner/substrate interface to just above its melting point. The radiant heater includes a black body radiating element to minimize color dependency of the energy absorption by the toner. The radiant heater has an extended zone to allow toner temperature levels to be achieved without excessive heating of the substrate. In the radiant heating zone, the time duration of the radiating of the toner (˜0.5 seconds) and the toner/substrate interface temperature (˜90° C.) are sufficient to promote viscoelastic softening of the overall toner composition.

The pre-heated substrate with toner is fed to the fixing nip of the fixing device. The temperature of the outer surface of the fixing roll is at or near the melt temperature, Wax Tₘ, of the wax component in the toner, i.e., about 90° C. A nip pressure of about 1000 psi is applied at the fixing nip to enable adequate flow of the toner material to the substrate to attain good adhesion and blending of multi-layered color toners. These results are demonstrated with both a crease metric, which evaluates adhesive fix to the substrate, and an abrasive rub metric, which assesses coalescence of the toner layer. With the toner material contacting the anodized aluminum surface using a relatively short dwell nip, and a light coating of release agent, an appropriate level of gloss is achieved on the coated and uncoated papers.

Warm-pressure fixing apparatus, systems, and methods in accordance with embodiments may be used to improve nominal performance, and enhance fused prints by e.g., improving fix, accommodating selectable gloss, e.g., higher, intermediate, and lower gloss levels. Warm-pressure fixing processes are advantageous over related art processes, including thermal fusing processes for reasons including enabling all media at speed, expanding roll material options or printable substrate options, improving image quality, and obviating time consuming make ready and expensive post-fixing processing measures. For example, under lower temperatures and higher pressures during fixing in accordance with embodiments, anodized aluminum rolls along with durable polyurethane have demonstrate good image quality and long life.

Systems, apparatus, and methods of embodiments also enhance images post-fixing processing. For example, as discussed, related art thermal fusers operate at very high temperatures, e.g., 150° C. to about 210° C. to fix dry toner to substrate. The toner, after fixing and prior to cooling, is vulnerable to offsetting to an adjacent surface, taking on the surface of whatever it comes into contact with, and differentially cooling by way of contact. Image quality suffers as a result. Ultra-low melting toners tend to increase the potential for image artifacts. Warm-pressure fixing in accordance with apparatus, systems, and methods of embodiments address these issues, among others.

Specifically, warm-pressure fixing apparatus, systems, and methods in accordance with embodiments may reduce post-fixing thermally related IQ defects and failures such as bricking or blocking, which impact end-use applications. For example, methods of embodiments include depositing marking material, e.g., toner, on a substrate, and with or without a pre-heating step, fixing the toner image to the substrate using moderate to high pressure and a lower temperature than that used in thermal fusing. Post-fixing, the substrate may be stacked, or arranged in close proximity to adjacent surfaces, without negatively impacting the image quality and/or substrate. Substrates may be cut sheets or a continuous web on a rewind spool. Warm-pressure fixing can obviate costly and space-consuming cooling equipment, making print options such as ultra-low melting toner printing systems cost-effective alternatives.

Warm-pressure fixing apparatus, systems, and methods accommodate a wide range of substrate options for various print jobs without expensive and time-consuming make-ready between jobs. Label printing, for example, is predominantly accomplished with flexography and offset lithography, which are not suited to short run times because of expensive plates/cylinders and time consuming press preparation. Related art digital printing systems, including ink jet systems, are limited by equipment costs, range of substrates, image quality, and image durability.

Methods, apparatus, and systems of embodiments incorporate warm-pressure fixing systems and/or devices, whether added as a module to an existing printing system or incorporated inline in digital print systems. Exemplary digital printing systems in accordance with embodiments may incorporate tandem engine intermediate belt xerography, image-on-image xerography, and tandem engine direct-to-paper xerography, among other types of systems. Systems may include tandem engines with intermediate belt transfer, including belt-to-belt transfer and biased transfer roll transfer. For example, systems may include systems in which an intermediate transfer belt is used to transfer an image to a substrate for fixing, and systems in which, e.g., a marking material is deposited directly onto a photoreceptor member, and then transferred directly to a substrate for fixing.

A transfer nip may be advantageously mechanically isolated from a fixing nip by way of tension isolation member(s), e.g., rolls. Isolation tension members may prevent motion quality related image defects during transfer. In accordance with an embodiment, systems may be web printing systems having a web transport system configured to minimize image transfer disturbances.

Apparatus, systems, and methods in accordance with embodiments may include a base print station and one or more supplemental marking stations. The supplemental marking station(s) may be configured to apply any color marking material, e.g., white. For example, web feed print systems may include a white marking material station positioned before a base print engine in a web feed direction. In an alternative embodiment, print systems may include a white marking material station positioned after the base print station in a web feed direction.

In another embodiment, systems may include one or more supplemental marking material stations in the base print engine. Specifically, the base print engine may include a supplemental gamut expanding marking station or a plurality of marking stations that apply marking material that is different in color than the, e.g., four colors provided in the base print engine. In an embodiment, systems may include an overcoat station positioned in and/or after the base print engine.

Systems in accordance with embodiments include a warm-pressure fixing device or system configured for fixing marking material deposited by the base print engine and/or supplemental marking stations. Systems may include more than one warm-pressure fixing system(s) and/or device(s), whether added as a module, or incorporated inline. Warm-pressure fixing device(s) and/or system(s) may be configured for supplementing other fixing methods and systems, including UV curing. Apparatus, systems, and methods of embodiments include packaging printing systems that may be used for web printing labels, flexible packaging, documents (e.g., web feed), signage, wallpaper, wallpaper borders, and other industrial applications.

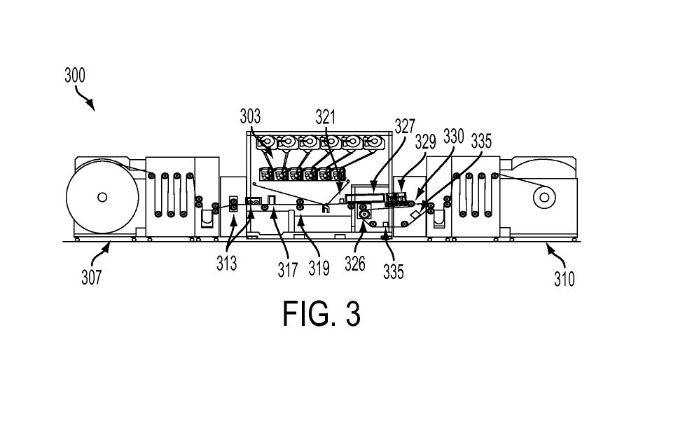

FIG. 3 shows a tandem engine printing system with an intermediate belt for electrophotographic image transfer and a fixing system in accordance with an embodiment. Specifically, the tandem engine printing system 300 includes a base print engine 303. The base print engine 303 may include marking material stations for one or more colors. The system 300 may include a continuous web substrate, such as a paper web. In embodiments, printing systems may use webs of other substrate material, or cut sheets, etc., as a substrate. The printing system 300 includes a web un-winder 307 and a web re-winder 310. The web may be unwound from un-winder 307 in a web feed process direction, e.g., toward the base print engine, and may be rewound by the web re-winder 310 after passing through the image transfer nip(s) and fixing nip(s).

FIG. 3 shows a web cleaner and plasma pre-treat station 313, which may be positioned before the base print station 303. After the web enters the base print station 303, the web may pass through a static eliminator station 317 and web metering system 319. The web metering system may be comprised of, e.g., rolls. The web may then pass through an image transfer nip at which an image may be transferred from an image transfer member 321 on which marking material has been deposited, to the web or other substrate. Image transfer may be enhanced by electrically biasing the image transfer member 321, or biasing translation members such as rolls about which the carrying member 321 and/or web translates, and/or roll(s) that form an image transfer nip.

In the printing system 300, an image transferred from image transfer member 321 to the web may be fused or fixed to the web. In methods, apparatus, and systems of embodiments, a warm-pressure fixing system is used, which may obviate the above-discussed disadvantages of thermal fusing and thermal fuser systems, and/or to enhance the quality of nominal prints.

The printing system 300 includes a fixing system 326 as shown in FIG. 3. In embodiments, the fixing system may be a warm-pressure fixing system that improves print quality, convenience, efficiency, and cost. FIG. 3 also shows a coalescence/leveling zone 327; and a UV curing system 329, which may be configured with cooling members, e.g., cooling rolls. The cooling rolls may be positioned behind the substrate during UV curing to assist in controlling substrate temperatures.

In alternative embodiments, pre-heating or softening of a toner layer may be carried out by contact roll heating, convection heating, laser heating, LED heating, etc. For some substrates, it may be advantageous to use cooling members, e.g., cooling rolls, behind the substrate during UV curing, to control the substrate temperature. Web cleaners, plasma pre-treatment and static control devices may be used in systems of embodiments. Optional devices for image quality diagnostics, including full width array scan bars or in-line spectrophotometers may be used for stable color printing.

FIG. 3 shows components for a plurality of distinct arrangements together for convenience. Specifically, systems in accordance with an embodiment may not include the fixing system 326 in the location shown for fixing marking material deposited by the base print engine 303. Instead, the UV curing system 329 may be used to fix marking material to the substrate. In such an arrangement, the coalescence/leveling zone 327 may be included as shown in FIG. 3, and positioned before the UV curing system 329. A fixing module may be used to enhance UV fixing.

In another embodiment, systems may not include the UV curing system 329 or the coalescence/leveling zone 327 shown in FIG. 3, but instead include a fixing system 326 configured to warm-pressure fix marking material to a substrate. The fixing system 326 may be located after a tension/isolation member 330. The tension isolation member 330 may comprise one or more rolls configured to isolate motion quality at the transfer nip from motion quality at a fixing nip defined by the fixing system 326.

In alternative embodiments, marking material may be fixed to a substrate, by warm-pressure fixing, before optional UV curing. For example, in an embodiment having both a fixing system 326 and a UV curing system 329, the fixing system 326 may be located before the UV curing system. The system does not include the coalescence/leveling zone 327 shown in FIG. 3. The fixing nip may provide coalescence/leveling. In an alternative embodiment, the fixing system 326 may be a multi-stage fixing system, and the pre-heating nip may provide coalescence/leveling. The web may pass by one or more processing stations 335 before being rewound by re-winder 310. For example, devices for static control and image diagnostics may be located along the web transport path for processing and monitoring the printed web.

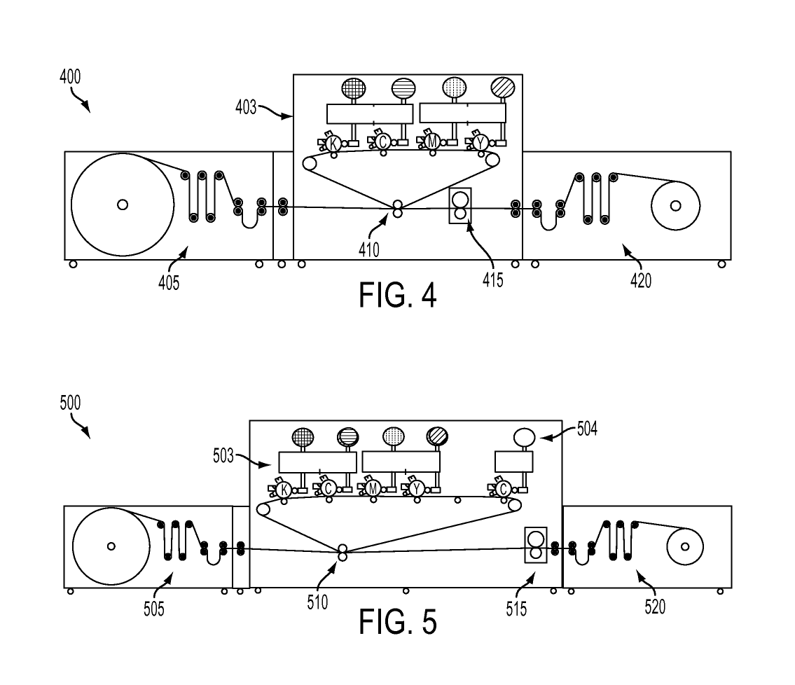

FIG. 4 shows a diagrammatical side view of an intermediate belt configuration printing system having a four color base print engine and a fixing system in accordance with an embodiment. Specifically, FIG. 4 shows a printing system 400 having a base print engine 403. The base print engine 403 includes four marking stations, each comprising marking material of a particular color. The base print engine 403 of FIG. 4 includes black, cyan, magenta, and yellow. The base print engine 403 shown in FIG. 4 includes an intermediate belt configuration with biased transfer roll image transfer.

The printing system 400 uses a continuous web substrate, although alternative embodiments may use alternative substrate types. The web may be a paper web, or may be a substrate suitable for use in packaging applications. The printing system 400 includes an un-winder 405. The web may be unwound from the un-winder 405 and fed in a process direction to the base print engine 403. The intermediate image transfer member of the base print engine 403 may form an image transfer nip 410. At the image transfer nip 410, the marking material deposited on the intermediate image transfer member may be transferred to the web.

After the web passes through the image transfer nip 410 to receive an image comprising a marking material, e.g., a deposited toner image, the image may be fixed to the substrate. The printing system 400 includes a warm-pressure fixing system 415 in accordance with embodiments. For example, the fixing system 415 may be a multi-stage fixing system or a single-stage fixing system in accordance with embodiments. The fixing system may be configured to accommodate a fixing nip temperature in a range of about 50° C. to about 120° C. Further the fixing system may be configured to accommodate a nip pressure lying in a range of about 300 psi to about 1500 psi. For example, the fixing system 415 may apply a nip pressure in a range of about 400 psi to about 1000 psi. In a preferred embodiment, the fixing system 415 may apply a nip pressure of about 500 psi to fix toner. Such temperatures and pressures may be adjusted according to marking material properties.

After fixing, the substrate may be stacked or rewound by re-winder 420. The warm-pressure fixing system 415 improves print quality and durability, expands substrate options, reduces costs, and increase efficiency. For example, post-processing such as stacking may contribute to image defects in related art thermal fusing systems whereas fixing apparatus, systems, and methods of embodiments address such problems.

FIG. 5 shows a diagrammatical side view of an intermediate belt configuration printing system having a four color base print engine and a supplemental marking station, and a fixing system in accordance with an embodiment. Specifically, FIG. 5 shows a printing system 500 having a base print engine 503. The base print engine 503 shown in FIG. 5 includes an intermediate belt configuration with biased transfer roll image transfer.

The base print engine 503 may include four marking stations, each comprising marking material of a particular color. The base print engine 503 of FIG. 5 includes black, cyan, magenta, and yellow. The base print engine 503 may include a supplemental marking station 504, and/or a supplemental marking station 504 may be positioned after marking stations of a base print engine 503, with respect to a process direction. In alternative embodiments, more than one supplemental marking station may be included. The supplemental marking station may be configured to deposit clear toner for overcoating or the like, or any other color of marking material.

The printing system 500 uses a continuous web substrate, although alternative embodiments may use alternative substrate types. The web may be a paper web, or may be a substrate suitable for use in packaging applications. The printing system 500 includes an un-winder 505. The web may be unwound from the un-winder 505 and fed in a process direction to the base print engine 503. The intermediate image transfer member of the base print engine 503 may form an image transfer nip 510. At the image transfer nip 510, the marking material deposited on the intermediate image transfer member may be transferred to the web.

After the web passes through the image transfer nip 510 to receive an image comprising a marking material, e.g., a deposited toner image, the image may be fixed to the substrate. The printing system 500 includes a warm-pressure fixing system 515 in accordance with embodiments. For example, the fixing system 515 may be a multi-stage fixing system or a single-stage fixing system in accordance with embodiments. The fixing system may be configured to accommodate a fixing nip temperature in a range of about 50° C. to about 120° C. Further the fixing system may be configured to accommodate a nip pressure lying in a range of about 300 psi to about 1500 psi. For example, the fixing system 515 may apply a nip pressure in a range of about 400 psi to about 1000 psi. In a preferred embodiment, the fixing system 515 may apply a nip pressure of about 500 psi to fix toner. Such temperatures and pressures may be adjusted according to marking material properties.

After fixing, the substrate may be stacked or rewound by re-winder 520. The warm-pressure fixing system 515 improves print quality and durability, expands substrate options, reduces costs, and increase efficiency. For example, post-processing such as stacking may contribute to image defects in related art thermal fusing systems whereas fixing apparatus, systems, and apparatus, systems, and methods of embodiments address such deficiencies.

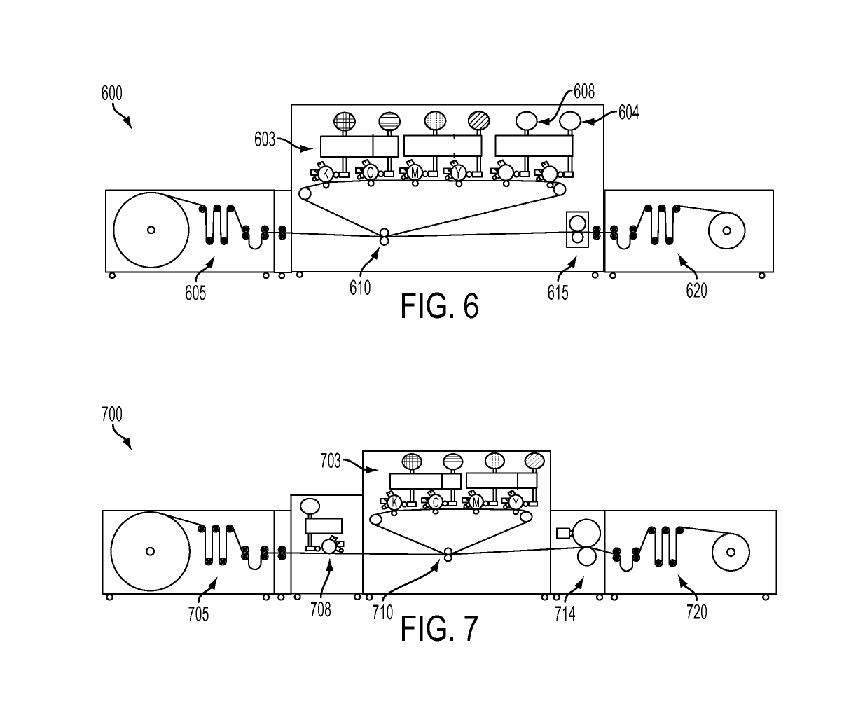

FIG. 6 shows a diagrammatical side view of an intermediate belt configuration printing system having a four color base print engine, a first and a second supplemental marking station, and a fixing system in accordance with an embodiment. Specifically, FIG. 6 shows a printing system 600 having a base print engine 603. The base print engine 603 shown in FIG. 6 includes an intermediate belt configuration with biased transfer roll image transfer.

The base print engine 603 may include four marking stations, each comprising marking material of a particular color. The base print engine 603 of FIG. 6 includes black, cyan, magenta, and yellow. The base print engine 603 may include a first supplemental marking station 604, and/or a supplemental marking station 604 may be positioned after marking stations of a base print engine 603, with respect to a process direction. The base print engine 603 may also include a second supplemental marking station 608, and/or a second supplemental marking station may be positioned after marking stations of the base print engine 603. In alternative embodiments, more than two supplemental marking stations may be included to, e.g., expand the color gamut of the base print engine. The supplemental marking stations may be configured to deposit clear toner for overcoating or the like, or any other color of marking material.

The printing system 600 uses a continuous web substrate, although alternative embodiments may use alternative substrate types. The web may be a paper web, or may be a substrate suitable for use in packaging applications. The printing system 600 includes an un-winder 605. The web may be unwound from the un-winder 605 and fed in a process direction to the base print engine 603. The intermediate image transfer member of the base print engine 603 may form an image transfer nip 610. At the image transfer nip 610, the marking material deposited on the intermediate image transfer member may be transferred to the web.

After the web passes through the image transfer nip 610 to receive an image comprising a marking material, e.g., a deposited toner image, the image may be fixed to the substrate. The printing system 600 includes a warm-pressure fixing system 615 in accordance with embodiments. For example, the fixing system 615 may be a multi-stage fixing system or a single-stage fixing system in accordance with embodiments. The fixing system may be configured to accommodate a fixing nip temperature in a range of about 50° C. to about 120° C. Further the fixing system may be configured to accommodate a nip pressure lying in a range of about 300 psi to about 1500 psi. For example, the fixing system 615 may apply a nip pressure in a range of about 400 psi to about 1000 psi. In a preferred embodiment, the fixing system 615 may apply a nip pressure of about 500 psi to fix toner. Such temperatures and pressures may be adjusted according to marking material properties.

After fixing, the substrate may be stacked or rewound by re-winder 620. The warm-pressure fixing system 615 improves print quality and durability, expands substrate options, reduces costs, and increase efficiency. For example, post-processing such as stacking may contribute to image defects in related art thermal fusing systems whereas fixing apparatus, systems, and methods of embodiments address such deficiencies.

FIG. 7 shows a diagrammatical side view of an intermediate belt configuration printing system having a four color base print engine, a white color marking material station positioned before the base print engine, and a warm-pressure fixing system positioned after the base print engine, in accordance with an embodiment. Specifically, FIG. 7 shows a printing system 700. The printing system 700 includes a base print engine 703. The base print engine 703 includes four marking stations, each comprising marking material of a particular color. The base print engine 703 of FIG. 7 includes black, cyan, magenta, and yellow colors. The base print engine 703 shown in FIG. 7 includes an intermediate belt configuration with biased transfer roll image transfer.

The printing system 700 uses a continuous web substrate. The web may be a paper web, or may be a different material such as those substrates suitable for use in packaging applications. The printing system 700 includes an un-winder 705. The web may be unwound from the un-winder 705 and fed in a process direction to the base print engine 703. The printing system 700 may include a supplemental marking station 708 positioned before the base print engine 703.

The supplemental marking station 708 may include a marking material of a particular color for depositing on the web. For example, the supplemental marking station 708 may include a white marking material for depositing on the web. The supplemental marking station 708 may include an associated fixing system (not shown) for fixing the marking material to the web prior to advancing the web to the base print engine 703. The fixing system may be a warm-pressure fixing system in accordance with embodiments.

After passing the supplemental marking station 708, the web may be advanced to the base print engine 703. The intermediate image transfer member of the base print engine 703 may form an image transfer nip 710. At the image transfer nip 710, the marking material deposited on the intermediate image transfer member may be transferred to the web.

After the web passes through the image transfer nip 710 to receive an image comprising a marking material, e.g., a deposited toner image, the image may be fixed to the web substrate. In alternative embodiments, the supplemental marking station 708 may be positioned after the base print engine 703 in a process feed forward direction. Such an arrangement may accommodate reverse printing where, for example, the marking material to be deposited by the supplemental marking station 708 is to be deposited in a layer furthest from the substrate, and/or where the image is viewed through the substrate, such as in certain packaging material applications.

The printing system 700 includes a warm-pressure fixing system 714. The warm-pressure fixing system 714 may be configured to define a fixing nip. At the fixing nip, the warm-pressure fixing system 714 may apply a pressure in a range of about 300 psi to about 1500 psi to fix toner to substrate, e.g., the web. Preferably, the fixing system 714 may apply a pressure of about 500 psi. At the fixing nip, the warm-pressure fixing system 714 may apply a temperature of about 50° C. to about 120° C. In an alternative embodiment, the fixing system 714 may be a multi-stage warm-pressure fixing system in accordance with embodiments.

After fixing, the substrate may be stacked or rewound by re-winder 720. Because the warm-pressure fixing system uses higher pressures and lower temperatures than those used by related art thermal fusers, warm-pressure fixing systems in accordance with embodiments address related art post-processing problems, as discussed. Specifically, warm-pressure fixing apparatus, systems, and methods of embodiments accommodate a broad range of substrate options and overcome issues associated with thermal fusing such as expensive cooling equipment, bricking when stacking printed substrates, etc.

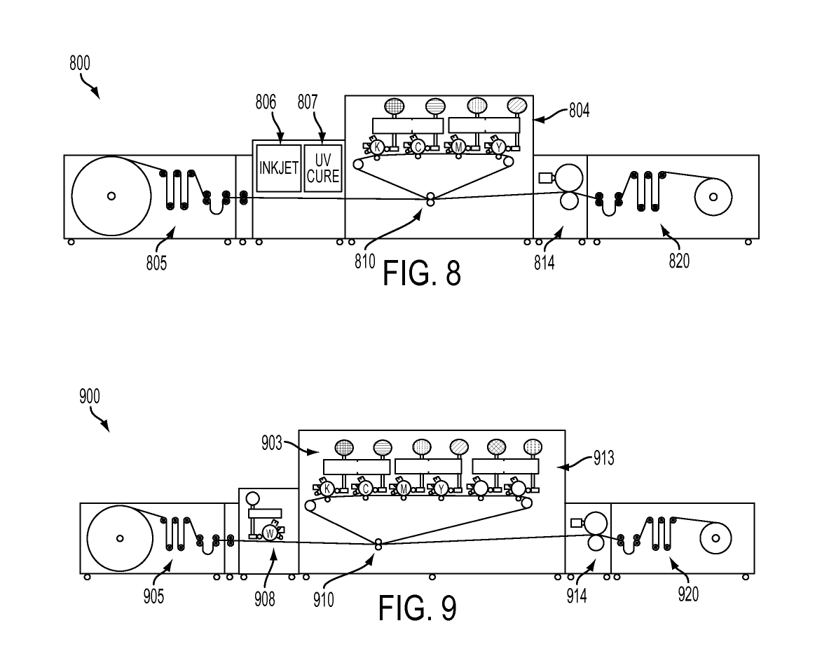

FIG. 8 shows a diagrammatical side view of an intermediate belt configuration printing system having a four color base print engine, an inkjet-based marking station and UV curing system positioned before the base print engine, and a warm-pressure fixing system positioned after the base print engine, in accordance with an embodiment. Specifically, FIG. 8 shows a printing system 800, which includes a base print engine 803. The base print engine 803 includes four marking stations, each comprising marking material of a particular color. The base print engine 803 of FIG. 8 includes black, cyan, magenta, and yellow colors. The base print engine 803 shown in FIG. 8 includes an intermediate belt configuration with biased transfer roll image transfer.

The printing system 800 uses a continuous web substrate. The web may be a paper web, or may be a different material such as those substrates suitable for use in packaging applications. The printing system 800 includes an un-winder 805. The web may be unwound from the un-winder 805 and fed in a process direction to the base print engine 803. The printing system 800 may include an inkjet marking station 806 positioned before the base print engine 803. The inkjet marking station may deposit a marking material of a particular color on the web. For example, the inkjet marking station may deposit white ink on the substrate.

In an embodiment, a UV curing station 807 may be positioned immediately after the inkjet marking station 806 for curing the deposited ink. In alternative embodiments the ink may be dried by other means now known or later developed. Such a configuration may accommodate substantially complete and continuous area coverage of a substrate area while minimizing ink supply defects. In alternative embodiments, the inkjet marking station 806 may be positioned after the base print engine 803 in a process feed forward direction. Such an arrangement may accommodate reverse printing where, for example, the marking material to be deposited by the inkjet marking station 806 is to be deposited in a layer furthest from the substrate, and/or where the image is viewed through the substrate, such as in certain packaging material applications.

After passing the inkjet marking station 806, the web may be advanced to the base print engine 803. The intermediate image transfer member of the base print engine 803 may form an image transfer nip 810. At the image transfer nip 810, the marking material deposited on the intermediate image transfer member may be transferred to the web.

After the web passes through the image transfer nip 810 to receive an image comprising a marking material, e.g., a deposited toner image, the image may be fixed to the web substrate. The printing system 800 includes a warm-pressure fixing system 814. The warm-pressure fixing system 814 may be configured to define a fixing nip. At the fixing nip, the warm-pressure fixing system 814 may apply a pressure in a range of about 300 psi to about 1500 psi to fix toner to substrate, e.g., the web. For example, the warm-pressure fixing system 814 may apply a pressure in a range of about 400 psi to about 1000 psi. Preferably, the fixing system 814 may apply a nip pressure of about 500 psi. The fixing system 814 may apply a temperature of about 50° C. to about 120° C. In alternative embodiments, the fixing system may be a multi-stage fixing system having a softening device that accommodates lower fixing temperatures.

After fixing, the substrate may be stacked or rewound by re-winder 820. The warm-pressure fixing system 814 may fix marking material to a substrate using higher pressures and lower temperatures than those used by related art thermal fusers. The above-discussed temperatures and pressures relate to toner. Temperatures and pressures applied to a warm-pressure fixing nip may vary according to a type of marking material used and/or type of substrate used. The warm-pressure fixing system accommodates a broad range of substrate options and overcomes issues associated with thermal fusing such as expensive cooling equipment, bricking when stacking printed substrates, etc.

FIG. 9 shows a diagrammatical side view of an intermediate belt configuration printing system having a four color base print engine, a white color marking material station positioned before the base print engine, and a warm-pressure fixing system positioned after the base print engine, a gamut expanding supplemental marking stations in the base print engine, in accordance with an embodiment. Specifically, FIG. 9 shows a printing system 900. The printing system 900 includes a base print engine 903. The base print engine 903 includes four marking stations, each comprising marking material of a particular color. The base print engine 903 of FIG. 9 includes black, cyan, magenta, and yellow colors. The base print engine 903 shown in FIG. 9 includes an intermediate belt configuration with biased transfer roll image transfer.

The printing system 900 uses a continuous web substrate. The web may be a paper web, or may be a different material such as those substrates suitable for use in packaging applications. The printing system 900 includes an un-winder 905. The web may be unwound from the un-winder 905 and fed in a process direction to the base print engine 903. The printing system 900 may include a supplemental marking station 908 positioned before the base print engine 903.

The supplemental marking station 908 may include a marking material of a particular color for depositing on the web. For example, the supplemental marking station 908 may include a white marking material for depositing on the web. The supplemental marking station 908 may include an associated fixing system (not shown) for fixing the marking material to the web prior to advancing the web to the base print engine 903. The fixing system may be a warm-pressure fixing system in accordance with embodiments.

After passing the supplemental marking station 908, the web may be advanced to the base print engine 903. The intermediate image transfer member of the base print engine 903 may form an image transfer nip 910. At the image transfer nip 910, the marking material deposited on the intermediate image transfer member may be transferred to the web.

The base print engine 903 may include four marking stations, each comprising marking material of a particular color. The base print engine 903 of FIG. 9 includes black, cyan, magenta, and yellow. The base print engine 903 may include a gamut expanding first supplemental marking station 912, and a second supplemental marking station 913, which may be positioned after marking stations of a base print engine 903, with respect to a process direction. In alternative embodiments, more than two supplemental marking stations may be included to, e.g., expand the color gamut of the base print engine. The supplemental marking stations may be configured to deposit clear toner for overcoating or the like, or any other color of marking material.

After the web passes through the image transfer nip 910 to receive an image comprising a marking material, e.g., a deposited toner image, the image may be fixed to the web substrate. The printing system 900 includes a warm-pressure fixing system 914. The warm-pressure fixing system 914 may be configured to define a fixing nip. At the fixing nip, the warm-pressure fixing system 914 may apply a pressure in a range of about 300 psi to about 1500 psi to fix toner to substrate, e.g., the web. For example, the fixing system 914 may apply a pressure in a range of about 400 psi to about 1000 psi, and preferably a pressure of about 500 psi. At the fixing nip, the warm-pressure fixing system 914 may apply a temperature of about 50° C. to about 120° C. In an alternative embodiment, the fixing system 914 may be a multi-stage warm-pressure fixing system in accordance with embodiments.

After fixing, the substrate may be stacked or rewound by re-winder 920. Because the warm-pressure fixing system uses higher pressures and lower temperatures than those used by related art thermal fusers, warm-pressure fixing systems in accordance with embodiments address related art post-processing problems, as discussed. Specifically, the warm-pressure fixing apparatus, systems, and methods of embodiments accommodate a broad range of substrate options and overcome issues associated with thermal fusing such as expensive cooling equipment, bricking when stacking printed substrates, etc.

Printing systems of embodiments discussed above include print engines wherein an image is formed on an image carrying member or image transfer belt, i.e., an intermediate image transfer belt, before being transferred to a substrate to be fixed thereon. Alternative embodiments may include photoreceptor arrangements wherein marking material is deposited directly on a photoreceptor member. In embodiments incorporating a photoreceptor arrangement, marking materials may deposited directly over one another on a photoreceptor member in succession to a form a marking material image. The photoreceptor member may be in the form of a drum, a belt, or any other suitable structure.

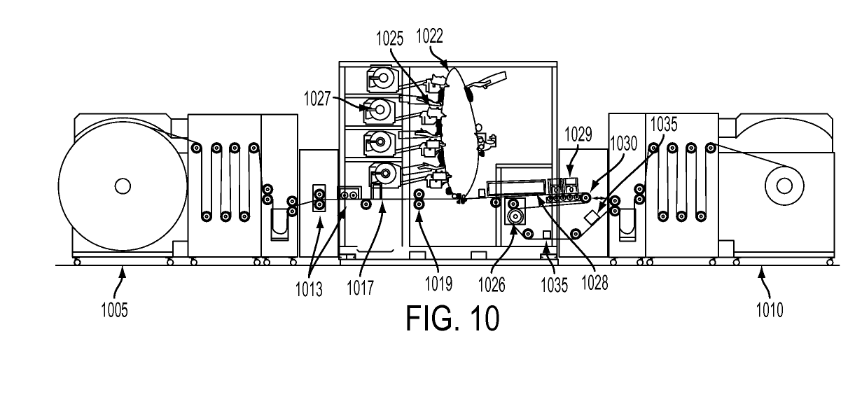

FIG. 10 shows a printing system having a base print engine with a photoreceptor arrangement and a warm-pressure fixing system in accordance with an embodiment. Specifically, FIG. 10 shows a printing system 1000 having a continuous web feed system that feeds forward in a process direction from un-winder 1005 to re-winder 1010. The web may pass through processing systems such as web cleaner and pre-plasma stations 1013. The web may also be processed by a static eliminator and sense station 1017. Before depositing marking material on the web, the web may be processed by a metering system 1019. The metering system 1019 may include one or more metering members, which may be in the form of rolls or other suitable structure. The metering system 1019 of the printing system 1000 includes two metering rolls that together define a metering nip through which the web may pass before having an image transferred thereon.

The printing system 1000 of FIG. 10 includes a base print engine 1022. The base print engine 1022 includes a photoreceptor member 1025. The photoreceptor member 1025 may be a translatable photoreceptor member such as a belt. In alternative embodiments, the photoreceptor member may be a drum that is rotatable. The photoreceptor member 1025 may carry marking material deposited thereon to an image transfer nip. At the image transfer nip, the marking material may be transferred to the web. The marking material may be deposited on the photoreceptor member 1025 by marking material stations 1027. Each marking material station 1027 may deposit marking material of a particular color on the photoreceptor member 1025. As the photoreceptor member 1025 translates, marking material stations 1027 may deposit marking material in succession, and over top of marking material applied by a preceding station. In this manner, an image, which may be a color image, may be built directly on the photoreceptor member for carrying to an image transfer nip, and transferring to the web at the image transfer nip.

In methods, apparatus, and systems of embodiments, after marking material or a marking material image is transferred from the photoreceptor member 1025 to the substrate; the image may be fixed to the substrate by a warm-pressure fixing system. The printing system 1000 includes a warm-pressure fixing system 1026. In embodiments, the warm-pressure fixing system may improve print quality, convenience, efficiency, and cost in accordance with embodiments. In addition to warm-pressure fixing, UV curing may be used to enhance image quality and durability.

FIG. 10 shows components for a plurality of distinct arrangements together for convenience. Specifically, systems in accordance with an embodiment may not include the fixing system 1026 in the location shown for fixing marking material deposited by the base print engine 1022. Instead, the UV curing system 1029 may be used to fix marking material to the substrate. In such an arrangement, the coalescence/leveling zone 1028 may be included as shown in FIG. 10, and positioned before the UV curing system 1029.

In another embodiment, systems may not include the UV curing system 1029 or the coalescence/leveling zone 1027 shown in FIG. 3, but instead include a fixing system 1026 configured to warm-pressure fix marking material to a substrate. The fixing system 1026 may be located after a tension/isolation member 1030. The tension isolation member 1030 may comprise one or more rolls configured to isolate motion quality at the transfer nip from motion quality at the fixing nip define by the fixing system 1026.

In alternative embodiments, marking material may be fixed to a substrate, by warm-pressure fixing, before optional UV curing. For example, in an embodiment having both a fixing system 1026 and a UV curing system 1029, the fixing system 1026 may be located before the UV curing system. The system does not include the coalescence/leveling zone 1028 shown in FIG. 10, and instead the fixing nip may provide coalescence/leveling. In an alternative embodiment, the fixing system 1026 may be a multi-stage fixing system, and the pre-heating nip may provide coalescence/leveling. The web may pass by one or more processing stations 1035 before being rewound by re-winder 1010. For example, devices for static control and image diagnostics may be located along the web transport path for processing and monitoring the printed web.

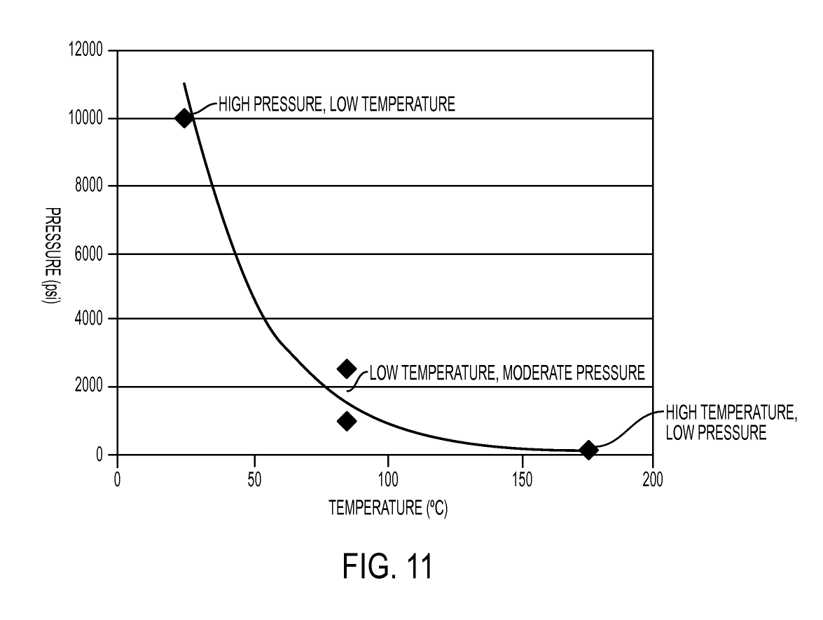

FIG. 11 shows a fixing nip pressure versus fixing temperature profile using a toner having a differential scanning calorimetry scan of heat flow versus temperature, used to achieve a particular image fix level as measured by the crease test. The data points in FIG. 11 represent a toner fixing process that uses low temperature and moderate pressure conditions at the fixing nip and, for comparison, a fixing process that uses low temperature (ambient temperature) and high pressure conditions, and a fixing process that uses high temperature and low pressure conditions. Apparatus, systems, and methods of embodiments are configured to fix marking material to substrate using, e.g., lower temperatures and moderate to high pressures at the fixing nip.

It will be appreciated that various ones of the above-disclosed, as well as other features and functions, or alternatives thereof, may be desirably combined into many other different systems or applications. Also, various presently unforeseen or unanticipated alternatives, modifications, variations or improvements therein may be subsequently made by those skilled in the art, which are also intended to be encompassed by the following claims.

What is claimed is:

1. A fixing module for an electrophotographic printing system that prints a toner image on a substrate, the fixing module comprising:
a first fixing member;
a second fixing member, the first fixing member and the second fixing member defining a fixing nip; and
wherein at least one of the first fixing member and the second fixing member is heated, and the first fixing member and the second fixing member apply a pressure of about 300 psi to about 1500 psi at the fixing nip to fix the toner to the substrate.

2. The fixing module of claim 1, wherein the at least one of the first fixing member and the second fixing member apply a pressure of about 500 psi.

3. The fixing module of claim 1, wherein the at least one of the first fixing member and the second fixing member is heated to a temperature of about 50° C. to about 120° C.

4. The fixing module of claim 1, further comprising:
a softening device, the softening device being heated for softening a marking material on a substrate before the substrate enters the fixing nip.

5. An electrophotographic printing system, comprising:
a base print engine that deposits marking material on a substrate; and
a fixing system, the fixing system having first fixing member and a second fixing member, the first fixing member and the second fixing member defining a fixing nip at which the fixing system applies a pressure in a range of about 300 psi to about 1500 psi to fix the marking material deposited on the substrate.

6. The printing system of claim 5, the base print engine having a plurality of marking stations, the base print engine further comprising:
at least one supplemental marking station arranged to deposit a marking material on the substrate after the substrate passes the plurality of marking stations.

7. The printing system of claim 5, the base print engine having a plurality of marking stations, the printing system further comprising:
at least one supplemental marking station arranged to deposit a marking material on the substrate, the at least one supplemental marking station being arranged at least one of before and after the plurality of color marking stations of the base print engine.

8. The printing system of claim 7, the at least one supplemental marking material station being an inkjet system for depositing inkjet marking material.

9. The printing system of claim 8, further comprising:
a UV curing system.

10. The printing system of claim 7, the at least one supplemental marking material station being configured to deposit a white marking material.

11. The printing system of claim 7, the at least one supplemental marking material station being configured to deposit an overcoat material.

12. The printing system of claim 5, the base print engine further comprising:
a photoreceptor member; and
a plurality of base marking material stations, wherein the base marking material stations deposit marking material on the photoreceptor member to form a marking material image;
an image transfer nip defined by the photoreceptor member, wherein the photoreceptor member contacts the substrate to transfer the marking material image to the substrate.

13. The printing system of claim 12, wherein the photoreceptor member is a belt-type photoreceptor.

14. The printing system of claim 5, the base print engine further comprising:
an intermediate image transfer member for transferring a marking material image to the substrate; and
at least one marking material station for depositing marking material on the intermediate image transfer member to build the image;
an image transfer nip defined by the intermediate transfer member whereby the image deposited by the at least one marking material station is transferred to the substrate.

15. The printing system of claim of claim 5, wherein the substrate is a continuous web.

16. The printing system of claim 15, further comprising:
a tension member contacting the web, the tension member interposing the base print engine and the fixing system, whereby the base print engine is mechanically isolated from the fixing system.

17. The printing system of claim 15, the base print engine further comprising:
an electrophotographic image transfer system that transfers an image from an image carrying member to the web to form a marking material image on the web.

18. The printing system of claim 5, wherein the pressure is about 500 psi.

19. The printing system of claim 5, further comprising:
at least one of the first fixing member and the second fixing member having a surface that contacts the substrate during fixing, the surface being an interchangeable surface comprising at least one of metallic, ceramic, composite, polymer, or polymer composite material.

20. The printing system of claim 5, further comprising:
at least one of the first fixing member and the second fixing member having surface comprising polyurethane or anodized aluminum.

21. A method of electrophotographic printing using a printing system having a base print engine and a fixing system, the fixing system having a first fixing member and a second fixing member, the first and second fixing members defining a fixing nip, the method comprising:
transferring a marking material image to a substrate; and
applying a pressure in a range of about 300 psi to about 1500 psi to fix the marking material to the substrate at the fixing nip.

22. The method of electrophotographic printing of claim 21, further comprising:
storing the substrate having the fixed marking material in contact with a second substrate, after warm-pressure processing.

23. The method of electrophotographic printing of claim 21, further comprising:
depositing marking material using a base marking material engine to form the marking material image on an image transfer member; and
depositing at least one of an overcoating and a white marking material on the substrate.

24. The method of claim 21, further comprising:
UV curing the marking material after the applying a pressure.

25. A method of enhancing marking material fixing, comprising:
depositing marking material on a substrate;
fixing the marking material to the substrate using one of contact and non-contact fixing methods; and
enhancing the fixing by passing the substrate having the fixed marking material through a fixing nip, wherein the fixing nip applies a pressure in a range of about 300 psi to about 1500 psi, and a temperature in a range of about 50° C. to about 120° C.

26. A printing system for printing marking material images on a broad range of substrates, the system comprising:
a printing means including a base print engine that deposits marking material on a substrate to form a marking material image;
a fixing means for fixing the marking material image to the substrate, the fixing means including a first fixing member and a second fixing member, the first fixing member and the second fixing member defining a fixing nip wherein the fixing means applies heat and a pressure of about 500 psi to fix the marking material to the substrate; and
a substrate translation means for feeding a substrate in a process direction, the substrate translation means including a storage means for storing the fixed substrate in contact with a second substrate after.
